(19) United States
(12) Patent Application Publication
(10) Pub. No.: US 2014/0320428 A1
(43) Pub. Date: Oct. 30, 2014

(54) INFORMATION PROCESSING APPARATUS, METHOD OF ADJUSTING SENSITIVITY OF TOUCHPAD, AND STORAGE MEDIUM

(71) Applicant: Kabushiki Kaisha Toshiba, Tokyo (JP)

(72) Inventor: Kyohei Matsuda, Ome-shi (JP)

(73) Assignee: Kabushiki Kaisha Toshiba, Tokyo (JP)

(21) Appl. No.: 14/173,605

(22) Filed: Feb. 5, 2014

(30) Foreign Application Priority Data
Apr. 26, 2013 (JP) 2013-093958

(51) Int. Cl. G06F 3/041

(52) U.S. Cl. CPC G06F 3/041
USPC 345/173

(57) ABSTRACT

According to one embodiment, an information processing apparatus includes a touchpad and a controller. The controller is configured to adjust a sensitivity of the touchpad. The controller is configured to set the sensitivity of the touchpad at a first value when a window of a first application program is inactive and to set the sensitivity of the touchpad at a second value different from the first value when the window of the first application program is active.

### CROSS-REFERENCE TO RELATED APPLICATIONS

This application is based upon and claims the benefit of priority from Japanese Patent Application No. 2013-093958, filed Apr. 26, 2013, the entire contents of which are incorporated herein by reference.

### FIELD

Embodiments described herein relate generally to an information processing apparatus including a touchpad.

### BACKGROUND

In recent years, various types of personal computers (PCs) have been widely spread. A touchpad is mounted on each of most of the PCs as a pointing device. By tapping a surface of the touchpad by a finger or moving the finger in contact with the touchpad on the surface of the touchpad, operations such as clicking, movement of a pointer, and screen scrolling can be executed. Various proposals on the touchpad have been made.

In addition, as for the touchpad, a palm rejection function is provided by a touchpad bender, etc. for prevention of an operation error caused by a pointer jump (resulting from an unintentional contact of a palm, etc. on the touchpad). The pointer jump indicates, for example, movement of an input cursor to the other position caused by touching the surface of the touchpad by mistake during typing on a keyboard for document preparation. When the pointer jump occurs, a typed document is input to a position to which the input cursor is moved. The palm rejection function is a function to prevent the pointer jump by cancelling the input in a case where a contact area on the touchpad is small. According to the function, occurrence of the pointer jump is decreased, but cannot be prevented at all.

In addition, a user can vary the sensitivity on the touchpad by himself/herself by touchpad settings, etc. If the sensitivity on the touchpad is lowered, occurrence of the pointer jump can be decreased, but the user may feel uncomfortable when the user wishes to operate the touchpad at high sensitivity.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an outer appearance of an information processing apparatus according to the embodiment.

FIG. 2 is an exemplary block diagram showing a system configuration of the information processing apparatus according to the embodiment.

FIG. 3 is an exemplary block diagram for explanation of a function of a sensitivity adjustment utility program operating in the information processing apparatus according to the embodiment.

FIG. 4 is an exemplary first illustration for explanation of adjusting the sensitivity of the touchpad by the sensitivity adjustment utility program operating in the information processing apparatus according to the embodiment.

FIG. 5 is an exemplary second illustration for explanation of adjusting the sensitivity of the touchpad by the sensitivity adjustment utility program operating in the information processing apparatus according to the embodiment.

FIG. 6 is an exemplary flowchart showing a procedure of adjusting the sensitivity of the touchpad by the sensitivity adjustment utility program operating in the information processing apparatus according to the embodiment.

### DETAILED DESCRIPTION

Various embodiments will be described hereinafter with reference to the accompanying drawings.

In general, according to one embodiment, an information processing apparatus includes a touchpad and a controller. The controller is configured to adjust a sensitivity of the touchpad. The controller is configured to set the sensitivity of the touchpad at a first value when a window of a first application program is inactive and to set the sensitivity of the touchpad at a second value different from the first value when the window of the first application program is active.

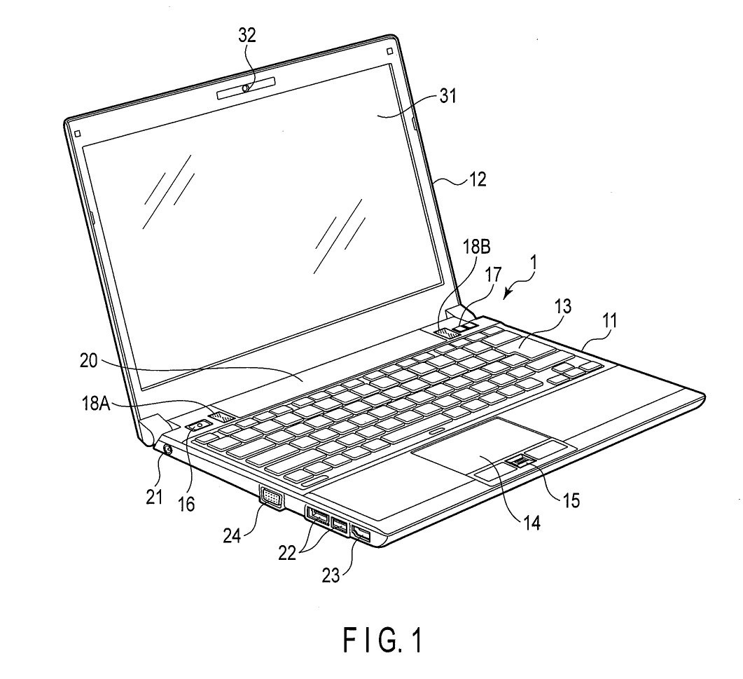

First, a configuration of an information processing apparatus according to one of the embodiments will be described with reference to FIG. 1. The information processing apparatus can be implemented as, for example, a notebook-type portable personal computer 1, etc.

FIG. 1 is an exemplary perspective view showing a computer 1 having a display unit opened as seen from a front side. The computer 1 is configured to be supplied with an electric power from a battery 20. The computer 1 includes a computer body 11 and a display unit 12. A display device such as a liquid crystal device (LCD) 31 is embedded in the display unit 12. Furthermore, a camera (Web camera) 32 is arranged at an upper end portion of the display unit 12.

The display unit 12 is attached to the computer body 11 so as to freely pivot between an opened position at which an upper surface of the computer body 11 is exposed and a closed position at which the upper surface of the computer body 11 is covered with the display unit 12. The computer body 11 has a housing shaped in a thin box. On the upper surface, a keyboard 13, a touchpad 14, a fingerprint sensor 15, a power switch 16 for power-on/power-off of the computer 1, some function buttons 17, and speakers 18A and 18B are arranged.

In addition, the computer body 11 is provided with a power supply connector 21. The power supply connector 21 is arranged on a side surface, for example, a left side surface of the computer body 11. An external power supply is detachably connected with the power supply connector 21. An AC adapter can be employed as the external power supply. The AC adapter is a power supply device configured to convert a commercial power supply (AC power) into DC power.

The battery 20 is detachably mounted on, for example, a rear end portion of the computer body 11. The battery 20 may be a battery built in the computer 1.

The computer 1 is driven by an electric power from the external power supply or an electric power from the battery 20. If the external power supply is connected to the power supply connector 21 of the computer 1, the computer 1 is driven by the electric power from the external power supply. The electric power from the external power supply is also used to charge the battery 20. The computer 1 is driven by the electric power from the battery 20 over a period during which the external power supply is not connected to the power supply connector 21 of the computer 1.

Furthermore, the computer body 11 is provided with some USB ports 22, an HDMI (High-Definition Multimedia Interface (registered trademark)) output terminal 23, a VGA (RGB) port 24, and a LAN connector 25 (not shown).

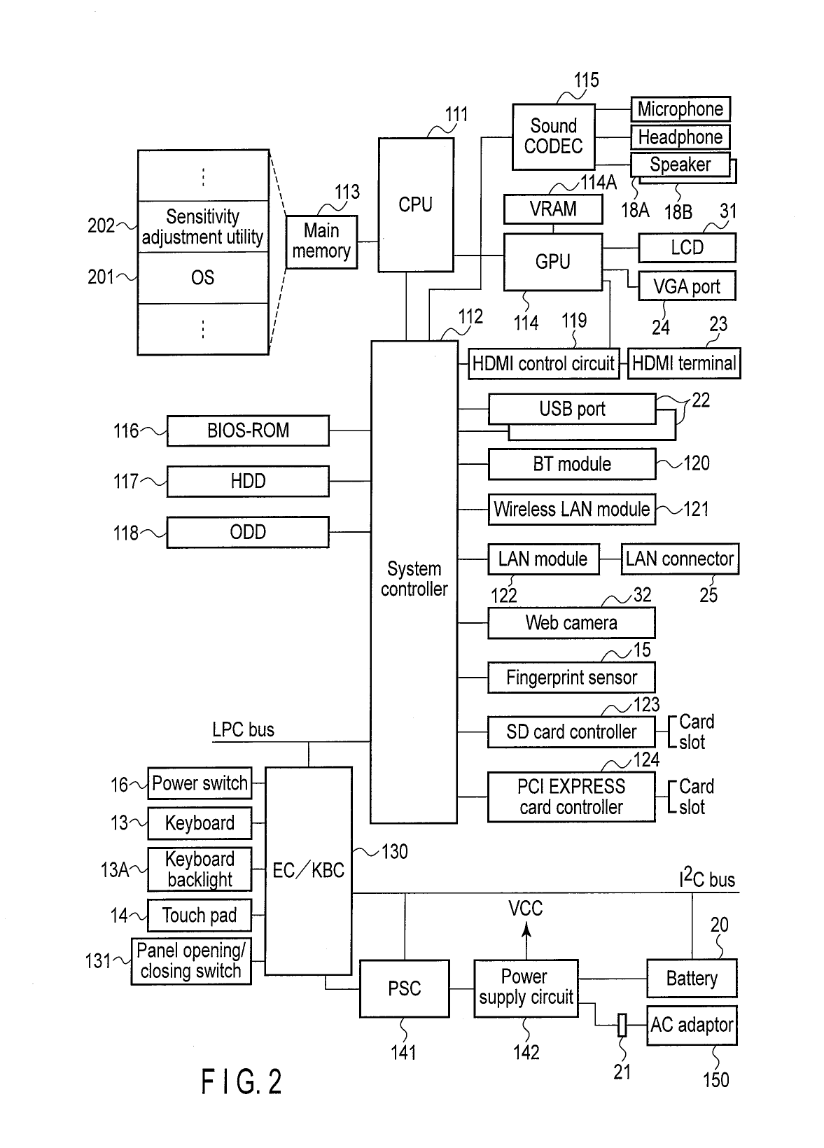

FIG. 2 shows a system configuration of the computer 1. The computer 1 includes a CPU 111, a system controller 112, a main memory 113, a graphics processing unit (GPU) 114, a sound codec 115, a BIOS-ROM 116, a hard disk drive (HDD) 117, an optical disk drive (ODD) 118, a BT (Bluetooth (registered trademark)) module 120, a wireless LAN module 121, a LAN module 122, an SD card controller 123, a PCI EXPRESS card controller 124, an embedded controller/keyboard controller IC (EC/KBC) 130, a keyboard backlight 13A, a panel opening/closing switch 131, a power supply controller (PSC) 141, a power supply circuit 142, etc.

The CPU 111 is a processor configured to control operations of respective components of the computer 1. The CPU 111 executes various types of software loaded from the HDD 117 onto the main memory 113. The software includes an operating system (OS) 201 and various types of application programs. The software further includes a sensitivity adjustment utility program 202 to be described later. The sensitivity adjustment utility program 202 is installed in the computer 1 as a resident program.

In addition, the CPU 111 also executes a basic input output system (BIOS) stored in the BIOS-ROM 116 which is a nonvolatile memory. The BIOS is a system program for hardware control.

The GPU 114 is a display controller configured to control the LCD 31 embedded in the display unit 12. The GPU 114 generates a display signal (LVDS signal) which should be supplied to the LCD 31 from display data stored in a video memory (VRAM) 114A. The GPU 114 can also generate an analog RGB signal and an HDMI signal from the display data. The analog RGB signal is supplied to an external display via the RGB port 24. HDMI terminal 23 can send an HDMI video signal (uncompressed digital image signal) and a digital audio signal to the external display by uses of a cable. An HDMI control circuit 119 is an interface which sends the HDMI video signal and the digital audio signal to the external display via the HDMI output terminal 23.

The system controller 112 is a bridge device which makes connection between the CPU 111 and each of the components. A serial ATA controller configured to control the hard disk drive (HDD) 117 and the optical disk drive (ODD) 118 is built in the system controller 112. The system controller 112 executes communication with each of the devices on an LPC (Low PIN Count) bus.

The EC/KBC 130 is connected to the LPC bus. The EC/KBC 130, the power supply controller (PSC) 141 and the battery 20 are interconnected via a serial bus such as an I²C bus.

The EC/KBC 130 is a power management controller which executes power management of the computer 1 and is implemented as a one-chip microcomputer in which, for example, a keyboard controller configured to control the keyboard (KB) 13, the touchpad 14, etc. is built. The EC/KBC 130 includes a function to power on and off the computer 1 in response to user operations of the power switch 16. The control to power on and off the computer 1 is executed by a cooperative operation of the EC/KBC 130 and the power supply controller (PSC) 141.

When the power supply controller (PSC) 141 receives an ON signal sent from the EC/KBC 130, the power supply controller (PSC) 141 controls the power supply circuit 142 to power on the computer 1. In addition, when the power supply controller (PSC) 141 receives an OFF signal sent from the EC/KBC 130, the power supply controller (PSC) 141 controls the power supply circuit 142 to power off the computer 1. The EC/KBC 130, the power supply controller (PSC) 141 and the power supply circuit 142 also operate with the electric power from the battery 20 or an AC adapter 150 over a period in which the computer 1 is powered off.

Furthermore, the EC/KBC 130 can turn on/off the keyboard backlight 13A arranged on a back surface of the keyboard 13. The EC/KBC 130 is connected to a panel opening/closing switch 131 configured to detect opening/closing of the display unit 12. If the opening of the display unit 12 is detected by the panel opening/closing switch 131, the EC/KBC 130 can also power on the computer 1.

The power supply circuit 142 generates the electric power (operational power supply) which should be supplied to each of the components, by using the electric power from the battery 20 or the electric power from the AC adaptor 150 connected to the computer body 11 as the external power supply.

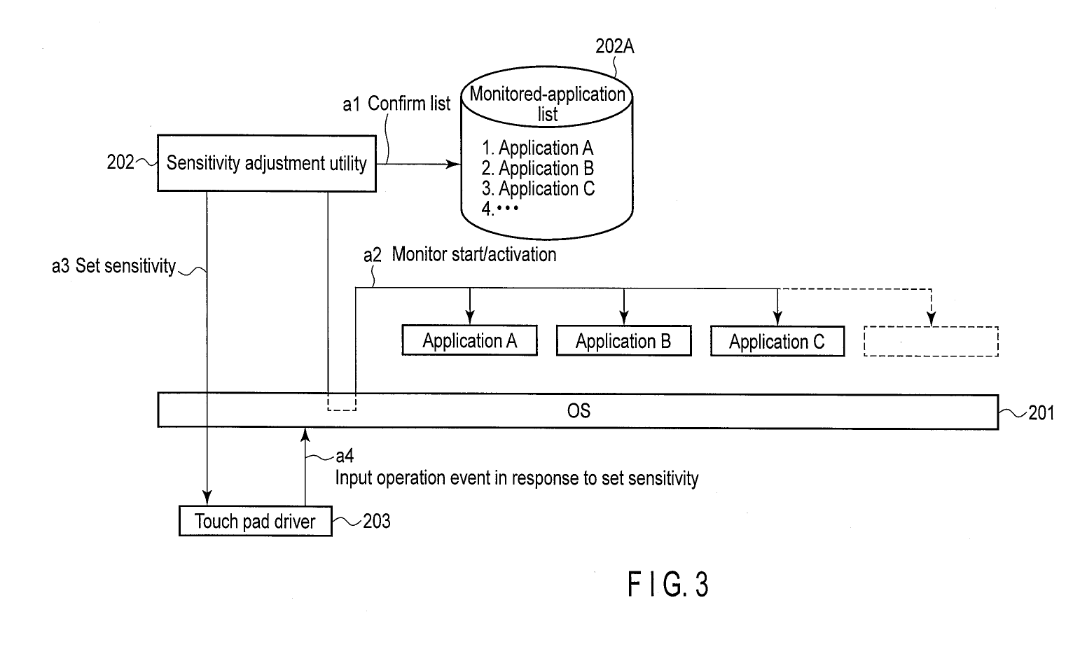

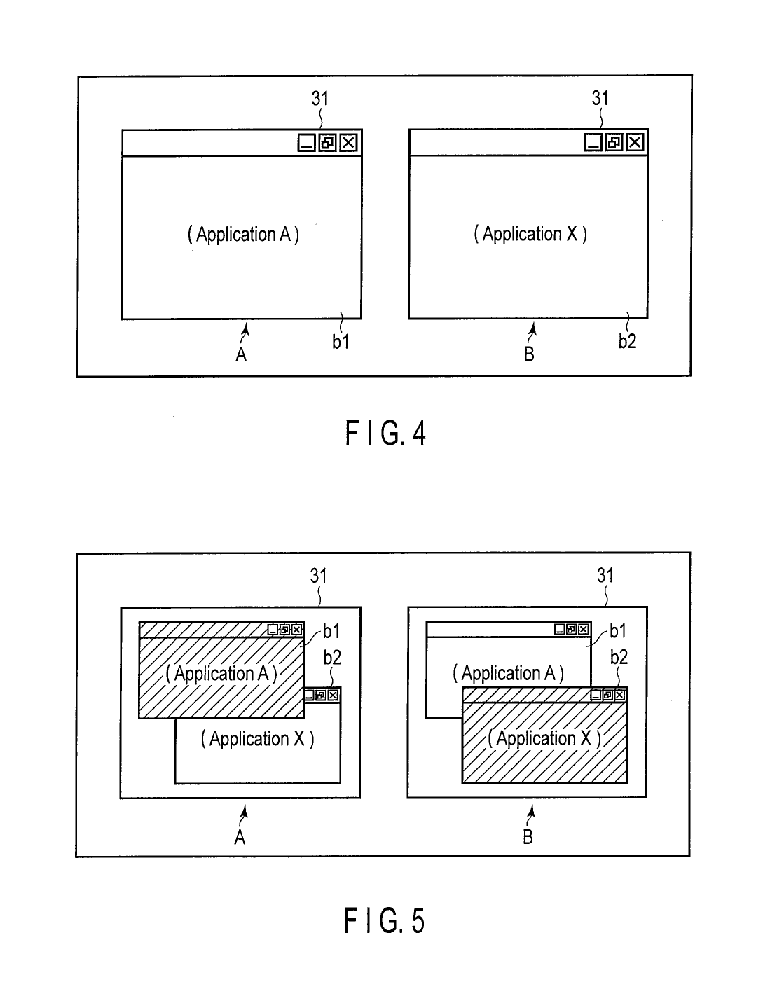

Next, a function of the sensitivity adjustment utility 202 operating in the computer 1 having the above configuration will be described with reference to FIG. 3, FIG. 4 and FIG. 5.

As described above, various types of software can be loaded from the HDD 117 onto the main memory 113 and executed by the CPU 111, in the computer 1. In addition, the computer 1 includes the keyboard 13 and the touchpad 13 as the input devices. For example, when software for viewing a Web page, which is called a browser or the like, is used, the touchpad 14 is mainly employed as the input device and, it is preferable that the touchpad 14 can be operated at high sensitivity. On the other hand, for example, when document preparation software or spreadsheet software is used, the keyboard 13 is mainly employed as the input device and, it is preferable that the sensitivity of the touchpad 14 should be lowered to prevent occurrence of an operation error. In the computer 1, the sensitivity of the touchpad is therefore adaptively adjusted by a sensitivity adjustment utility program 203. This point will be described below in detail.

FIG. 3 is an exemplary block diagram for explanation of a function of the sensitivity adjustment utility program 202 operating in the information processing apparatus 1.

The sensitivity adjustment utility program 202 adaptively adjusts the sensitivity of the touchpad 14 based on a monitored-application list 202A. More specifically, the sensitivity adjustment utility program 202 first confirms an application program which is a subject of monitoring by referring to the monitored-application list 202A (a1 in FIG. 3). It is assumed that a list of application programs to lower the sensitivity of the touchpad 14 is recorded in the monitored-application list 202A.

The monitored-application list 202A is a data file stored in, for example, the HDD 117 of the computer 1 when the sensitivity adjustment utility program 202 is installed in the computer 1. For example, an interface function to regularly access a Web site managed by a vender of the computer 1 or the sensitivity adjustment utility program 202 and to maintain and manage the monitored-application list 202A to be in a latest state (recommended by the vender) may be incorporated into the sensitivity adjustment utility program 202. In addition, an interface function to allow the user to customize the monitored-application list 202A may be incorporated into the sensitivity adjustment utility program 202.

If the sensitivity adjustment utility program 202 confirms application programs to be monitored, the sensitivity adjustment utility program 202 monitors occurrence of an event that any one of the application programs has been started (activated) or an event that a window of any one of the application programs has been activated, via the OS 201 (a2 in FIG. 3). The start (activation) of the application program or the activation of the window can be monitored by, for example, using a DLL (Dynamic link library) provided by the vender of the OS 201.

If it is detected that any one of the application programs has been started or that a window of any one of the application programs has been activated, the sensitivity adjustment utility program 202 discriminates whether the application program is the application program to be monitored or not. If the application program is not the application program to be monitored, the sensitivity adjustment utility program 202 requests a touchpad driver 203 to set a first value of high sensitivity which is a standard value and, if the application program is the application program to be monitored, the sensitivity adjustment utility program 202 requests the touchpad driver 203 to set a second value of lower sensitivity than the sensitivity of the first value which is the standard value (a3 in FIG. 3). The touchpad driver 203 is a module configured to control the touchpad 14.

The sensitivity adjustment utility program 202 may manage setting the sensitivity of the touchpad 14 to be either the first value or the second value, and request the touchpad driver 203 to set the sensitivity at a timing at which the first value should be changed to the second value or the second value should be changed to the first value.

The touchpad driver 203 inputs an operation event on the touchpad 14, in the OS 201, in response to the set sensitivity (a4 in FIG. 3). The touchpad driver 203 discriminates that a touch operation has been executed on the touchpad 14 when, for example, an area of contact on the touchpad 14 is equal to or greater than a threshold value. By making the threshold value great (first value<second value), the sensitivity of the touchpad 14 can be lowered. A variation width of the threshold value, i.e., the second value may be set by the above-described interface function.

It is assumed here that an application program A is recorded in the monitored-application list 202A and that an application program X is not recorded in the monitored-application list 202A. For example, the application program A is document preparation software, spreadsheet software, etc. for which the sensitivity of the touchpad 14 needs to be lowered, and the application program X is the browser, etc. by which the touchpad 14 needs to be operated at high sensitivity.

In this case, the sensitivity of the touchpad 14 can be varied by the operation of the sensitivity adjustment utility program 202 when the user of the computer 1 starts the application program A (“A” in FIG. 4) or when the user of the computer 1 starts the application program X (“B” in FIG. 4) as shown in, for example, FIG. 4. More specifically, the adaptive adjustment of the sensitivity of the touchpad 14 is implemented such that the touchpad 14 is set to be at a low sensitivity when the application program A is started and that the touchpad 14 is set to be at the high sensitivity (standard) when the application program X is started. In FIG. 4, b1 indicates a window for the application program A, and b2 indicates a window for the application program X. Each of the windows b1 and b2 is displayed in full screen on the LCD 31, in FIG. 4.

The OS 201 corresponding to multi-window. Therefore, it is adequately possible for the user of the computer 1 to simultaneously use the application program A and the application program X. In this case, too, the adaptive adjustment of the sensitivity of the touchpad 14 is implemented such that the touchpad 14 is set to be at the low sensitivity when the window of the application program A is in the active state (“A” in FIG. 5) and that the touchpad 14 is set to be at the high sensitivity (standard) when the window of the application program X is in the active state (“B” in FIG. 5), as shown in, for example, FIG. 5.

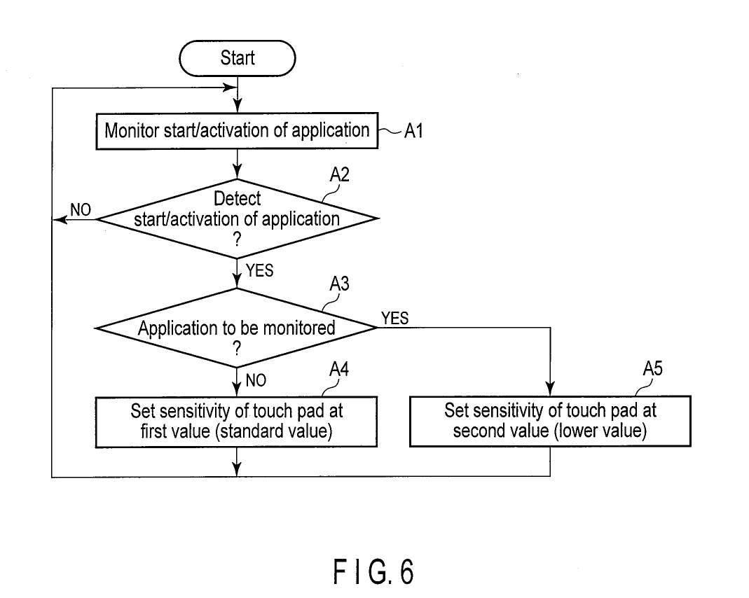

FIG. 6 is an exemplary flowchart showing a procedure of adjusting the sensitivity of the touchpad by the sensitivity adjustment utility program 202 operating in the information processing apparatus 1.

The sensitivity adjustment utility program 202 monitors the start of the application programs or the activation of the window (block Al). If the sensitivity adjustment utility program 202 detects that any one of the application programs has been started or that the window has been activated (YES in block A2), the sensitivity adjustment utility program 202 discriminates whether the application program is the application to be monitored or not (block A3).

If the application program is not the application to be monitored (NO in block A3), the sensitivity adjustment utility program 202 sets the sensitivity of the touchpad 14 to be at the first value (standard) (block A4). On the other hand, if the application program is the application to be monitored (YES in block A3), the sensitivity adjustment utility program 202 sets the sensitivity of the touchpad 14 to be at the second value (lower value) (block A5).

Thus, in the computer 1, the sensitivity of the touchpad 14 can be properly adjusted in temporary situations, without damaging the sense of operation, by the operation of the sensitivity adjustment utility program 202.

Incidentally, the example of lowering the sensitivity of the touchpad 14 if the started application program or the application program having the window activated is the application program to be monitored as recorded in the monitored-application list 202A has been described. If the started application program or the application program having the window activated is the application program to be monitored as recorded in the monitored-application list 202A, the sensitivity of the touchpad 14 may be set to be higher. In addition, the value which should be set as the sensitivity of the touchpad 14 may also be recorded in the monitored-application list 202A, for each of the application programs recorded in the monitored-application list 202A as the subject to be monitored. If the application program to be monitored is started or the window of the application program is activated, the sensitivity adjustment utility program 202 sets the sensitivity of the touchpad 14 to be the value recorded in the monitored-application list 202A in association with the application program.

In addition, various operations on the touchpad 14 such as single tap caused by tapping the touchpad 14 at one time by the finger, double tap caused by tapping the touchpad 14 at two times by the finger, movement of the pointer caused by moving the finger on the touchpad 14, and scrolling of the screen caused by moving the finger up and down on the right end portion of the touchpad 14, can be executed. Thus, the touchpad driver 203 can be set to accept the setting of the sensitivity of the touchpad 14 at every operation, and a parameter indicating which operation lowers the sensitivity may be recorded in the monitored-application list 202A, for each of the application programs recorded in the monitored-application list 202A as the subject to be monitored.

If the application program to be monitored has been started or if the window of the application program has been activated, the sensitivity adjustment utility program 202 requests the touchpad driver 203 to lower the sensitivity of the touchpad 14, for an operation indicated by a parameter, based on the parameter recorded in the monitored-application list 202A in association with the application program. Of course, the sensitivity of the touchpad 14 for a specific operation can be adjusted to be higher. The sensitivity of the touchpad 14 can be adjusted to be lower for an operation and can be adjusted to be higher for the other operation, for example, in the same application program, depending on the use of the monitored-application list 202A.

As described above, since the screen scrolling operation can be executed by the touchpad 14, the amount of screen scrolling corresponding to the scrolling operation can be adjusted for each application program, by using the monitored-application list 202A.

Besides the above, for example, the sensitivity adjustment utility program 202 monitors the input from the keyboard 13, and the adjustment of the sensitivity such as lowering the sensitivity of the touchpad 14 in a case where the keyboard input is frequently executed or increasing the sensitivity of the touchpad 14 in a case where keyboard input is rarely executed can be executed regardless of use condition of the application programs.

Since all of the procedure of the present embodiment can be implemented by software, the same advantages as those of the present embodiment can be easily achieved by installing the software in a general computer by means of a computer-readable storage medium.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a touchpad; and
a controller configured to adjust a sensitivity of the touchpad, wherein the controller is configured to set the sensitivity of the touchpad at a first value when a window of a first application program is inactive and to set the sensitivity of the touchpad at a second value different from the first value when the window of the first application program is active.

2. The apparatus of claim 1, wherein the controller is configured to set the sensitivity of the touchpad at a third value when the first application program is unstarted and to set the sensitivity of the touchpad at a fourth value different from the third value when the window of the first application program is started.

3. The apparatus of claim 1, wherein the controller is configured to adjust an amount of screen scrolling corresponding to a scrolling operation on the touchpad.

4. The apparatus of claim 1, wherein the controller is configured to adjust the sensitivity of the touchpad for each operation on the touchpad.

5. The apparatus of claim 1, wherein the controller comprises an interface configured to set an application program as the first application program.

6. The apparatus of claim 5, wherein the interface is capable of setting the second value.

7. The apparatus of claim 6, wherein the interface is capable of setting two or more application programs as the first application program and setting the second value for each of the two or more application programs.

8. The apparatus of claim 6, further comprising a communicator,
wherein the interface is configured to set at least one of the first application program and the second value, based on information obtained from other information processing apparatus via the communicator.

9. The apparatus of claim 1, wherein the controller comprises an interface configured to set the second value.

10. A method of adjusting a sensitivity of a touchpad for an information processing apparatus, comprising:
setting the sensitivity of the touchpad at a first value when a window of a first application program is inactive and at a second value different from the first value when the window of the first application program is active.

11. The method of claim 10, wherein the setting comprises setting the sensitivity of the touchpad at a third value when the first application program is unstarted and at a fourth value different from the third value when the window of the first application program is started.

12. A computer-readable, non-transitory storage medium having stored thereon a computer program which is executable by a computer, the computer program controlling the computer to function as:
a controller configured to adjust a sensitivity of a touchpad, wherein the controller is configured to set the sensitivity of the touchpad at a first value when a window of a first application program is inactive and to set the sensitivity of the touchpad at a second value different from the first value when the window of the first application program is active.

13. The medium of claim 12, wherein the controller is configured to set the sensitivity of the touchpad at a third value when the first application program is unstarted and to set the sensitivity of the touchpad at a fourth value different from the third value when the window of the first application program is started.
